(19) United States
(12) Patent Application Publication
(10) Pub. No.: US 2007/0038393 A1
(43) Pub. Date: Feb. 15, 2007

(54) Vibration monitoring

(76) Inventors: Frederic Borah, Merrick, NY (US); Anthony Leib JR., Commack, NY (US); George Fkiaras, Farmingdale, NY (US); Ruben F. Lah, West Jordan, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/502,342

(22) Filed: Aug. 10, 2006

Related U.S. Application Data
(60) Provisional application No. 60/707,929, filed on Aug. 12, 2005.

(51) Int. Cl. G01H 1/00

(52) U.S. Cl. 702/56

(57) ABSTRACT

Systems, devices, and methods for monitoring the status of a cutting tool during delayed decoker unit operation, and systems for remotely monitoring the level of coke or foam in a drum during the coking process. One or more sensors or accelerometers is coupled to a location in a delayed coking unit operation to read vibrations emanating from the component that the respective accelerometers are located on. Vibrational data is transmitted to a computer system that manipulates the data to provide useful information that an operator of a delayed coking unit operation may view.

### RELATED APPLICATIONS

This patent application claims priority to: (1) U.S. Provisional patent application Ser. No. 60/707,929, filed Aug. 12, 2005 and entitled VIBRATION MONITORING DEVICE; and (2) U.S. Provisional patent application Ser. No. 60/777,621, filed Feb. 28, 2006 and entitled VIBRATION MONITORING SYSTEM.

### BACKGROUND

1. Field of the Invention

The present invention relates to vibration monitoring devices and methods for using the same. Specifically, the present invention relates to determining the level of coke or coke byproducts inside a coker drum and to noninvasive signature recognition systems using accelerometers and mathematical algorithms for signature detection.

2. Background Information

Petroleum refining operations in which crude oil is processed frequently produce residual oils. Many oil refineries recover valuable products from heavy residual hydrocarbons. Residual oil, when processed in a delayed coker, is heated in a furnace to a temperature sufficient to cause destructive distillation in which a substantial portion of the residual oil is converted, or “cracked” to usable hydrocarbon products and the remainder yields petroleum coke, a material composed mostly of carbon.

Generally, the delayed coking process involves heating the heavy hydrocarbon feed from a fractionation unit, then pumping the heated heavy feed into a large steel vessel commonly known as a coke drum. The unvaporized portion of the heated heavy feed settles out in the coke drum, where the combined effect of retention time and temperature causes the formation of coke. Vapors from the top of the coke vessel are returned to the base of the fractionation unit for further processing into desired light hydrocarbon products. Normal operating pressures in coke drums typically range from twenty-five to fifty p.s.i, and the feed input temperature may vary between 800° F. and 1000° F.

The structural size and shape of the coke drum varies considerably from one installation to another. Coke drums are generally large, upright, cylindrical, metal vessels ninety to one-hundred feet in height, and twenty to thirty feet in diameter. Coke drums have a top head and a bottom portion fitted with a bottom head. Coke drums are usually present in pairs so that they can be operated alternately. Coke settles out and accumulates in a vessel until it is filled, at which time the heated feed is switched to the alternate empty coke drum. While one coke drum is being filled with heated residual oil, the other vessel is being cooled and purged of coke.

Coke removal, also known as decoking, begins with a quench step in which steam and then water are introduced into the coke filled vessel to complete the recovery of volatile, light hydrocarbons and to cool the mass of coke. After a coke drum has been filled, stripped and then quenched so that the coke is in a solid state and the temperature is reduced to a reasonable level, quench water is drained from the drum through piping to allow for safe unheading of the drum. The drum is then vented to atmospheric pressure when the bottom opening is unheaded, to permit removing coke. Once the unheading is complete, the coke in the drum is cut out of the drum by high pressure water jets.

Decoking is accomplished at most plants using a hydraulic system comprised of a drill stem and drill bit that direct high pressure water into the coke bed. A rotating combination drill bit, referred to as the cutting tool, is typically about twenty-two inches in diameter with several nozzles, and is mounted on the lower end of a long hollow drill stem about seven inches in diameter. The drill bit is lowered into the vessel, on the drill stem, through a flanged opening at the top of the vessel. A “bore hole” is drilled through the coke using the nozzles, which eject high pressure water at an angle between approximately zero and twenty-three degrees up from vertical. This creates a pilot bore hole, about two to three feet in diameter, for the coke to fall through.

After the initial bore hole is complete, the drill bit is then mechanically switched to at least two horizontal nozzles in preparation for cutting the “cut” hole, which extends to the full drum diameter. In the cutting mode the nozzles shoot jets of water horizontally outwards, rotating slowly with the drill rod, and those jets cut the coke into pieces, which fall out the open bottom of the vessel, into a chute that directs the coke to a receiving area. In all employed systems the drill rod is then withdrawn out the flanged opening at the top of the vessel. Finally, the top and bottom of the vessel are closed by replacing the head units, flanges or other closure devices employed on the vessel unit. The vessel is then clean and ready for the next filling cycle with the heavy hydrocarbon feed.

In some coke-cutting systems, after the boring hole is made, the drill stem must be removed from the coke drum and reset to the cutting mode. This takes time, is inconvenient and is potentially hazardous. In other systems the modes are automatically switched. Automatic switching within the coke drum oftentimes results in drill stem clogging, which still requires the drill stem to be removed for cleaning prior to completing the coke-cutting process. Often, in automatic switching systems, it is difficult to determine whether or not the drill stem is in cutting or boring mode, because the entire change takes place within the drum. Mistakes in identifying whether the high pressure water is cutting or boring lead to serious accidents. Thus, coke-cutting efficiency is compromised because the switching operator does not know whether or not the cutting process is complete or simply clogged.

If the hydro-cutting system is not shut off before the drill stem is raised out of the top drum opening, operators are exposed to the high pressure water jet and serious injuries, including dismemberment, occur. Thus, operators are exposed to significant safety hazards from exposure to high pressure water jets in close proximity to the vessel being decoked, when manually changing the cutting head from the boring to cutting mode or when an operator has not accurately been able to access whether the head is cutting, boring or off.

Another problem encountered during the coking process is the difficultly in determining the level of coke at the top of the drum. Similarly, the level of foam located on top of the coke is also difficult to determine. Numerous serious problems, known to those skilled in the art, can occur if the coke level gets too high or if the foam gets into the feed lines connected to the drum.

### SUMMARY OF EMBODIMENTS OF THE INVENTION

The present invention relates to systems for remotely monitoring the status of a cutting tool during delayed decoker unit operation, and systems for remotely monitoring the level of coke or foam in a drum during the coking process. The former systems relate to systems for allowing operators involved in removing solid carbonaceous residue, referred to as “coke,” from large cylindrical vessels called coke drums to determine the status of the decoking operation from a remote location. The latter systems relate to systems for allowing operators involved in monitoring coke and/or foam levels in the drum during coking to more accurately and efficiently prevent foamovers and disastrous results resulting from coke levels from rising too high.

Some embodiments relate to continuous monitoring and detection of reduced material thickness in elbows and pipes which are carrying high temperature and/or high pressure fluids or gases.

In some embodiments, the monitoring systems may be utilized to measure bearing wear. In a preferred embodiment, bearing deterioration can be detected before failure occurs on critical rotating machinery.

In some embodiments, the monitoring systems may be used for detecting coke clogging the furnace pipes that are heating the petroleum before going into the coke drum.

In some embodiments, the monitoring systems may be used to monitor/detect the movement of fluids/gas in pipes.

Preferred embodiments relate to systems which utilize vibration monitoring systems to receive useful information regarding the decoking or coking operation. Some embodiments relate to systems that use acoustical monitoring systems, temperature monitoring systems, and/or pressure monitoring systems to receive such useful information.

Preferred embodiments of the invention relate to a system that allows an operator to remotely detect the status of a cutting tool while cutting coke within a coke drum, and to remotely detect when the tool has switched between the “boring” and the “cutting” modes, while cutting coke within a coke drum reliably, and without raising the drill bit out of the coke drum for mechanical alteration or inspection.

Preferred embodiments of the invention also relate to a system that allows an operator to remotely measure coke or foam levels within a coke drum via use of vertically positioned accelerometers.

Preferred embodiments provide a visual display which indicates the status of the decoking or coking operation. In some embodiments, a visual display allows the operator to determine what mode the cutting tool is presently in. In some embodiments, a visual display includes display of a signal run through an FFT algorithm.

In some embodiments, vibrational data is utilized to provide information regarding the mechanical status of the cutting tool of a delayed decoker unit; in some embodiments, the data is utilized to provide information regarding the coke and/or foam levels with respect to the top of the drum. Preferred embodiments utilize a vibration monitoring device comprising an accelerometer. In preferred embodiments, the vibration monitoring device may be attached to one or more locations in the delayed decoker unit.

In some embodiments, some of these measurements are relayed by a wireless device to a network access point and/or to a repeater which relays the signal from the wireless device to network access points. In other embodiments, the data generated by the vibration monitoring devices is transmitted via a wired connection to a computer system without the use of a wireless device. In some embodiments, the data received at the network access point is relayed to a computer system where the vibration data may be monitored and utilized.

In some embodiments, the data received from the vibration monitoring device is converted by software applications to a useable form. In preferred embodiments, data is run through a fast Fourier transform (“FFT”), which converts the data into an FFT fingerprint that may be utilized as a signature associated with the different modes of operation during a decoking operation.

Some embodiments comprise a vibration monitoring device comprising: an accelerometer, wherein the accelerometer provides an output signal; at least one network access point which receives the output from the vibration monitoring device; software for converting the raw data from the output signal into a useable wave form; and a display apparatus which either informs an operator of the status of the cutting tool in a coke drum, or informs an operator of the levels of coke and/or foam in the drum during coking.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1A shows a representative computer-based system in accordance with some embodiments of the present invention;

FIG. 1B illustrates a basic refinery flow diagram;

FIGS. 2A and 2B illustrate alternative embodiments of an operational layout utilized to assess the status of the cutting tool during decoking operation;

FIG. 3 illustrates an embodiment of a coke drum with a partially lowered drill stem;

FIG. 4 illustrates an embodiment of a coke drum with a fully raised drill stem;

FIG. 5 illustrates an embodiment showing two accelerometers placed on a stationary pipe that supplies water to a drill;

FIG. 6 illustrates an embodiment of a display containing real time frequencies and wave forms associated with cutting, boring, and drilling in a decoking operation;

FIG. 7 shows a simulation setup for testing the use of accelerometers in determining coke levels in a coke drum; and

FIG. 8 shows an example of a display of an accelerometer output signal.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of the systems, devices, and methods of the present invention, as represented in the accompanying Figures, is not intended to limit the scope of the invention as claimed, but is merely representative of some of the embodiments of the invention.

Embodiments of the invention will be best understood by reference to the drawings wherein like parts are designated by like numerals throughout. Although portions of the following more detailed description is divided into sections, it shall be noted that the creation of these sections is not intended to be limiting in any way, but is simply provided as convenience to the reader.

1. General Discussion of Computer-Based Systems and Devices

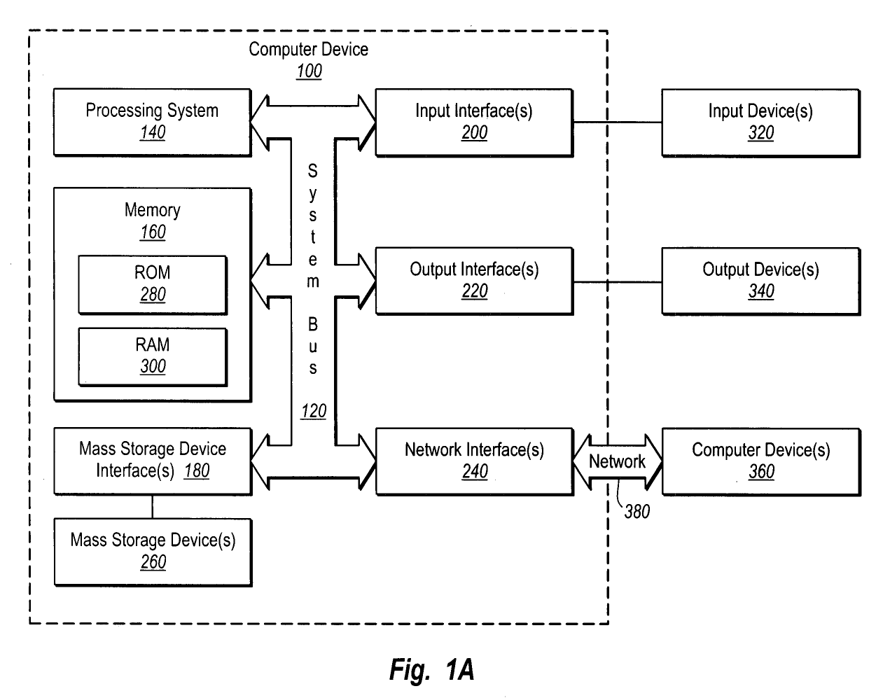

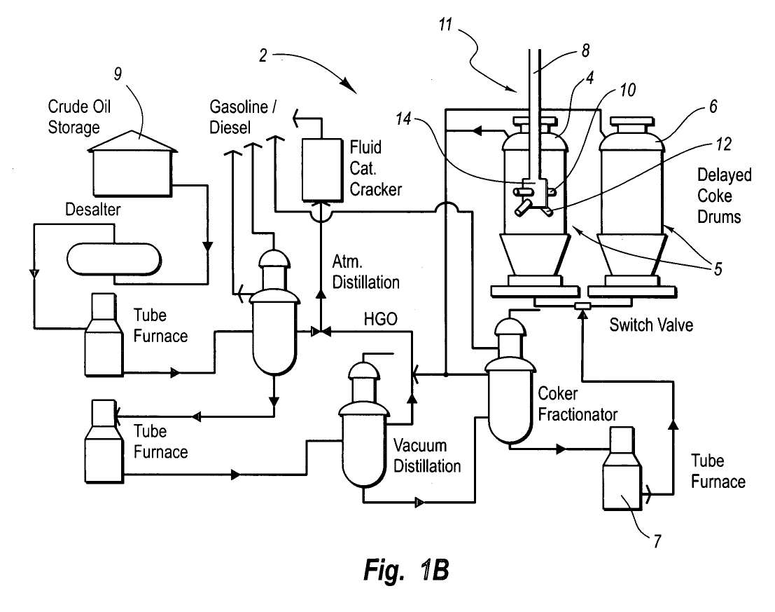

FIG. 1A and the corresponding discussion are intended to provide a general description of a computer-based environment, a suitable operating environment in which some embodiments of the invention may be implemented. One skilled in the art will appreciate that the invention may incorporate one or more computer devices in a variety of system configurations, including a variety of network-based configurations. Also, embodiments of the present invention may embrace one or more computer-readable media configured to include or potentially include thereon data or computer executable instructions for manipulating data. Computer executable instructions—for example, software code, data structures, objects, programs, routines, program modules, etc.—cause one or more computer devices to perform one or more finctions and comprise one type of means for implementing the methods or steps of embodiments of the present invention. Examples of computer-readable media include various types of random-access memory (“RAM”) media, read-only memory (“ROM”) media, compact disks (“CDs”), digital video disks (“DVDs”), hard drives, memory sticks, floppy disks, an electronic signal, or any other device or component that is capable of providing data or executable instructions for a computer device. Electronic signals are typically embodied in a light medium or carrier wave.

With reference to FIG. 1A, a representative system for implementing the invention may include computer device 100, which may be a general-purpose or special-purpose computer. For example, computer device 100 may be a personal computer, a notebook computer, a personal digital assistant (“PDA”) or other hand-held electronic device, a workstation, a minicomputer, a mainframe, a supercomputer, a multi-processor system, a network computer, a processor-based electronic device, etc. The term “computer device” herein is used generally and may refer either to a single computer device or to multiple computer devices, whether stand-alone or networked.

Computer device 100 may include a system bus 120, which may be configured to connect various components of the computer device 100 and may enable data to be exchanged between the components. System bus 120 may include one of a variety of bus structures including a memory bus or memory controller, a peripheral bus, or a local bus that uses any of a variety of bus architectures. Typical components connected by system bus 120 may include a processing system 140 and memory 160. Other components may include one or more mass storage device interfaces 180, input interfaces 200, output interfaces 220, and/or network interfaces 240.

Processing system 140 may include one or more processors, such as a central processor and optionally one or more other processors designed to perform a particular function or task. It is typically processing system 140 that executes computer-readable instructions found in memory 160, which in turn may be embodied in computer-readable media such as RAM or ROM media, magnetic hard disks, removable magnetic disks, magnetic cassettes, optical disks, etc.

Memory 160 may be embodied in one or more computer-readable media that may be configured to include thereon data or instructions for manipulating data, and may be accessed by processing system 140 through system bus 120. Memory 160 may include, for example, ROM 280, used to permanently store information, and/or RAM 300, used to temporarily store information. ROM 280 may include a basic input/output system (“BIOS”) having one or more routines that are used to establish communication, such as during start-up of computer device 100. RAM 300 may include one or more program modules, such as one or more operating systems, software applications, and/or program data.

One or more mass storage device interfaces 180 may be used to connect one or more mass storage devices 260 to system bus 120. The mass storage devices 260 may be incorporated into or may be peripheral to computer device 100 and allow computer device 100 to retain large amounts of data. Optionally, one or more of the mass storage devices 260 may be removable from computer device 100. Examples of mass storage devices include hard disk drives, magnetic disk drives, tape drives, and optical disk drives. A mass storage device 260 may read from and/or write to a magnetic hard disk, a removable magnetic disk, a magnetic cassette, an optical disk, or other computer-readable medium. Mass storage devices 260 and their corresponding computer-readable media may provide nonvolatile storage of data and/or executable instructions that may include one or more program modules such as an operating system, one or more software applications, program modules, program data, etc. Such executable instructions are examples of means for implementing steps or methods disclosed herein.

One or more input interfaces 200 may be employed to enable a user to enter data and/or instructions to computer device 100 through one or more corresponding input devices 320. Examples of such input devices include but are not limited to: a keyboard, a mouse, a trackball, a touch screen, a light pen, a stylus or other pointing device, a microphone, a joystick, a game pad, a satellite dish, a scanner, a camcorder, a digital camera, etc. Examples of input interfaces 200 that may be used to connect the input devices 320 to the system bus 120 include a serial port, a parallel port, a game port, a universal serial bus (“USB”) port, a firewire (IEEE 1394), etc.

One or more output interfaces 220 may be employed to connect one or more corresponding output devices 340 to system bus 120. Examples of output devices 340 include a monitor or display screen, a speaker, a printer, etc. A particular output device 340 may be integrated with or be peripheral to computer device 100. Examples of output interfaces 220 include a video adapter, an audio adapter, a parallel port, etc.

One or more network interfaces 240 may enable computer device 100 to exchange information with one or more other local or remote computer devices, illustrated generally at 360, via a network 380 that may include wired and/or wireless connections. Examples of network interfaces 240 include a network adapter for connection to a local area network (“LAN”) or a modem, wireless link, or other adapter for connection to a wide area network (“WAN”), such as the Internet. The network interface 240 may be incorporated with or peripheral to computer device 100. In a networked system, accessible program modules or portions thereof may be stored in a remote memory storage device. Furthermore, in a networked system, computer device 100 may participate in a distributed computing environment, where functions or tasks are performed by a plurality of networked computer devices.

2. General Discussion of the Delayed Coking Process

FIG. 1B illustrates an embodiment of a refinery operation 2. In the typical delayed coking process, high boiling petroleum residues are fed to one or more coke drums 5 where they are thermally cracked into light products and a solid residue—petroleum coke. The coke drums 5 are typically large cylindrical vessels having a top head and a conical bottom portion fitted with a bottom head. The fundamental goal of coking is the thermal cracking of very high boiling point petroleum residues into lighter fuel fractions. Coke is a byproduct of the process. Delayed coking is an endothermic reaction with a furnace 7 supplying the necessary heat to complete the coking reaction in a drum 5. The exact mechanism is very complex, and out of all the reactions that occur, only three distinct steps have been isolated: 1) partial vaporization and mild coking of the feed as it passes through the furnace 7; 2) cracking of the vapor as it passes through the coke drum 5; and 3) cracking and polymerization of the heavy liquid trapped in the drum 5 until it is converted to vapor and coke.

The process is extremely temperature-sensitive with the varying temperatures producing varying types of coke. For example, if the temperature is too low, the coking reaction does not proceed far enough and pitch or soft coke formation occurs. If the temperature is too high, the coke formed generally is very hard and difficult to remove from the drum with hydraulic decoking equipment. Higher temperatures also increase the risk of coking in the furnace tubes or the transfer line. As stated, delayed coking is a thermal cracking process used in petroleum refineries to upgrade and convert petroleum residuum into liquid and gas product streams leaving behind a solid concentrated carbon material, or coke. Furnace 7 is used in the process to reach thermal cracking temperatures, which range upwards of 1,000° F. With short residence time in the furnace 7, coking of the feed material is thereby “delayed” until it reaches large coking drums 5 downstream of the heater. In normal operations, there are two coke drums, here designated individually at 4 and 6, so that when one is being filled or is “on-line” (such as drum 6), the other may be “off-line” (such as drum 4) so that it can be purged of the manufactured coke. It shall be noted that, except when the discussion necessitates specific reference to an on-line drum 6 or to an off-line drum 4, reference herein to one or more coke drums in general shall be indicated by the number 5.

In a typical petroleum refinery process, several different physical structures of petroleum coke may be produced. These are, namely, shot coke, sponge coke, and/or needle coke (hereinafter collectively referred to as “coke”), and are each distinguished by their physical structures and chemical properties. These physical structures and chemical properties also serve to determine the end use of the material. Several uses are available for manufactured coke, some of which include use as fuel for burning, use as calcined coke in the aluminum, chemical, or steel industries, or use as gasified coke that is able to produce steam, electricity, or gas feedstock for the petrochemicals industry.

To produce the coke, a delayed coker feed originates from a supply of crude oil 9, travels through a series of process members, and finally empties into one of the coke drums 5 used to manufacture coke. The delayed coking process typically comprises a batch-continuous process, which means that the process is ongoing or continuous as the feed stream coming from the furnace 7 alternates filling between the two or more coke drums 5. As mentioned, while one drum is on-line filling up with coke, the other is being stripped, cooled, decoked, and prepared to receive another batch. In the past, this has proven to be an extremely time and labor intensive process, with each batch in the batch-continuous process taking approximately 12 to 20 hours to complete. In essence, hot oil, or “resid” as it is commonly referred to, from the tube furnace 7 is fed into one of the coke drums 5 in the system. The oil is extremely hot and produces hot vapors that condense on the colder walls of the coke drum 5. As the drum 5 is being filled, a large amount of liquid runs down the sides of the drum 5 into a boiling turbulent pool at the bottom. As this process continues, the hot resid and the condensing vapors cause the coke drum walls to heat. This naturally, in turn, causes the resid to produce less and less of the condensing vapors, which ultimately causes the liquid at the bottom of the coke drum 5 to start to heat up to coking temperatures. After some time, a main channel is formed in the coke drum 5, and as time goes on, the liquid above the accumulated coke decreases and the liquid turns into a more viscous type tar. This tar keeps trying to run back down the main channel which can coke at the top, thus causing the channel to branch. This process progresses up through the coke drum 5 until the drum is full, wherein the liquid pools slowly turn to solid coke. When the first coke drum is full, the hot oil feed is switched to the second coke drum, and the first coke drum is isolated, steamed to remove residual hydrocarbons, cooled by filling with water, opened, and then decoked. This cyclical process is repeated over and over again throughout the manufacture of coke.

The decoking process is the process used to remove the coke from the drum 5 upon completion of the coking process. Due to the shape of the coke drum 5, coke accumulates in the area near and attaches to the flanges or other members used to close off the opening of the coke drum during the manufacturing process. To decoke the drum 5, the flanges or members must first be removed or relocated. In the case of a flanged system, once full, the coke drum 5 is vented to atmospheric pressure and the top flange (typically a 4-foot diameter flange) is unbolted and removed to enable placement of a hydraulic coke cutting apparatus 11. After the cooling water is drained from the vessel, the bottom flange (typically a 7-foot-diameter flange) is unbolted and removed. This process is commonly known as “de-heading” because it removes or breaks free the head of coke that accumulates at the surface of the flange.

Once the flanges are removed, the coke is removed from the drum 5 by drilling a pilot hole from top to bottom of the coke bed using high pressure water jets. Following this, the main body of coke left in the coke drum 5 is cut into fragments which fall out the bottom and into a collection bin, such as a bin on a rail cart, etc. The coke is then dewatered, crushed and sent to coke storage or a loading facility.

3. Vibration Monitoring Device

Although the present invention is intended to cover the use of vibration monitoring systems throughout a delayed coker unit system, and the devices of the present invention may be utilized to monitor vibration at any point in the delayed coker unit operation, one ordinarily skilled in the art will recognize that the invention as explained and described herein may also be designed and used in other environments where monitoring vibration may provide useful data regarding mechanical operations.

Some embodiments relate to systems that use acoustical monitoring systems to receive useful information regarding the decoking operation. Some embodiments relate to systems that use temperature monitoring systems to receive useful information regarding the decoking operation. Some embodiments relate to systems that use pressure monitoring systems to receive useful information regarding the decoking operation.

While the majority of this discussion focuses primarily on the use of vibration monitoring systems as an exemplary embodiment of the present invention, the following description is equally germane to the use of acoustical, temperature, and/or pressure monitoring systems. It is contemplated that the use of acoustical, temperature, and/or pressure monitoring systems could be used to replace the vibration monitoring systems as described herein, or be used in combination with the vibration monitoring systems as described herein. Accordingly, the following discussion is not limited to vibration monitoring systems. Rather, vibration monitoring systems are a non-limiting example of preferred embodiments of the present invention.

Likewise, as the present invention is especially useful with respect to the coking and decoking processes, the discussion herein relates specifically to these manufacturing areas. It is foreseeable, however, that the present invention may be adapted for use in other manufacturing processes that produce various elements or byproducts other than coke. Such other processes should thus be considered within the scope of the invention.

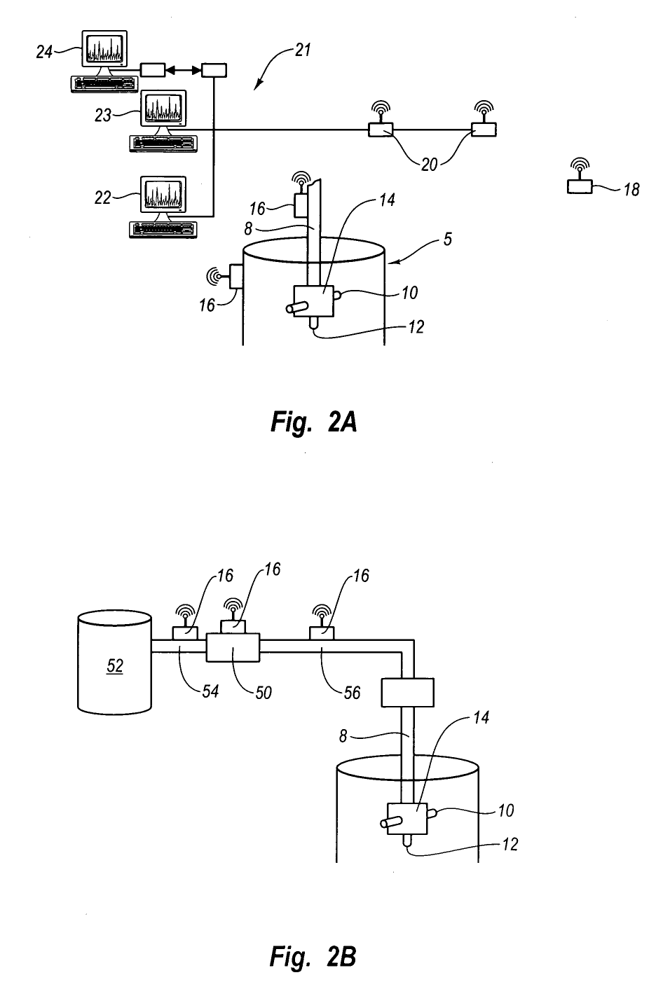

Referring now to FIG. 2A, a vibration monitoring system is shown for monitoring during the delayed coker unit operation. In FIG. 2A, a decoking system is depicted, the decoking system including a drill stem 8 and a cutting head 14 for cutting coke inside a drum 5. Cutting head 14 further comprises nozzles for boring 12 and nozzles for cutting 10. Nozzles for boring 12 are generally downward-facing, and nozzles for cutting 10 are generally horizontally oriented.

The vibration monitoring system comprises a sensor or transducer (preferably a vibration sensor such as an accelerometer) 16 coupled to at least one position within the delayed coker unit system and operatively coupled to a computer system 21. One or more accelerometers 16 may be placed on a component of the coker unit system to measure vibrations of the respective component; FIG. 2A shows two accelerometers placed thereon. Moreover, accelerometers 16 may be placed at any position or location on the coker unit system. FIG. 2A shows one accelerometer 16 placed on the outside of the drum 5, and one accelerometer 16 placed on the drill stem 8 (note that the accelerometers 16 may be placed on any location on the drum 5 or the drill stem 8 and are not limited to the specific locations shown). FIG. 2B shows accelerometers 16 placed on a first fluid line 16, a water or fluid pump 50, and a second fluid line 16 wherein the coker unit system shown includes a fluid reservoir 52 (again, accelerometer 16 placement is not limited to the specific locations shown).

The accelerometers 16 may also be placed in any orientation within the coker unit system. For example, FIG. 2A shows the accelerometer 16 on the drill stem 8 being placed in a vertical orientation, and the accelerometer 16 on the outside of the coke drum 5 in a horizontal orientation. The accelerometers 16 of the present invention may be attached to the drill stem 8, for example, so as to coincide with the drill stem's radial axis, rotational axis, longitudinal axis, horizontal axis, and/or vertical axis. Accordingly, the type of data acquired from an accelerometer 16 will depend upon the placement and the orientation of the accelerometer 16.

The sensors or accelerometers 16 preferably collect vibration data from one or more points in the coker unit system, and the data is transmitted to the computer system 21. Depending on the orientation of the accelerometer 16, the accelerometer 16 may be used to measure vibration in one or more axes. In preferred embodiments of the present invention, the accelerometer 16 measures vibration in one axis such as a horizontal or vertical axis. In some embodiments, multiple accelerometers 16 may be used at a single location to measure vibration in multiple axes. In some embodiments, the accelerometer 16 measures vibration in two or more axes. In a non-limited example, one accelerometer 16 may be used to measure vibration in a horizontal axis, and another accelerometer 16 may be used to measure vibration in a vertical axis.

Referring again to FIG. 2A, computer system 21 may include one or more of the following: an active repeater 18, a network access point 20, a local computer device, a remote computer device 24, and/or another computer device or other component 23. It is contemplated that connections between components within the computer system 21, or to and from the computer system 21, may comprise wired or wireless connections, regardless of what the Figures illustrate in the depicted embodiments.

In some embodiments of the present invention, the accelerometer 16 measures vibration associated with the operational status of the cutting tool 14 (for example, whether the cutting tool is in cutting, boring, or ramping modes—ramping being the process of switching from boring to cutting or vice versa) in a given coke drum 5. When the drill is in boring mode and water is being ejected from high pressure nozzles 12 to cut a bore hole through the solid coke resident in the off-line coke drum 4, the accelerometer 16 will measure vibrations that are produced as a result of the boring process. The data received by the accelerometer 16 during the boring process (or during other processes such as cutting or ramping processes) may be transmitted wirelessly to active repeaters 18, directly to a network access point 20, or to another computer device 23 in the computer system 21. Wireless repeaters 18 preferably relay data to network access points 20, but may relay data to any computer device 23 in the computer system 21.

Once received at access points 20 or at other points in the computer system 21, the data produced by the accelerometer 16 is transmitted to a component in the computer system 21 and may be stored in a database. The data may be amplified, exported to a Fast Fourier Transform (“FFT”), calibrated, and/or transformed. The resulting wave form may then be used to create a FFT fingerprint. Accordingly, as the drill stem 8 is in a boring mode, data created by the vibrational nature of boring is translated into a FFT fingerprint that represents and thereby identifies the boring process for a given coke drum. The same process can take place with respect to the cutting and ramping modes.

It is contemplated by the present invention that each individual coke drum may have a unique fingerprint. Accordingly, the present invention contemplates using a software which is capable of identifying the unique fingerprint of a given coke drum 5, and which is capable of producing and/or interpreting modified data (for example, an FFT fingerprint) that would allow an operator to readily ascertain that the cutting tool was presently boring, cutting, or ramping.

When the drill 8 has successfully completed going through the solid coke in the coke drum 5 and a bore hole has been created, an operator switches the flow of water from the boring nozzles 12 to the cutting nozzles 10. In semi-automated and automated systems, the drill head 14 remains in the coke drum 5 and is not visible to the operator. Accordingly, without a means of monitoring the status of the drill head 14 (whether it is in boring, cutting or ramping mode), the operator cannot be certain that the drill head 14 has successfully switched from boring mode to cutting mode. In some embodiments of the invention, the accelerometer 16 attached to a portion of the coking apparatus measures the vibration changes as the drill is switched from boring to cutting.

Another embodiment demonstrates additional features of some embodiments of the present invention. In a non-limiting example, one or more accelerometers 16 placed at one or more mentioned locations in a delayed coker unit operation collect data during the delayed coker unit operation. The data collected by the accelerometers 16 and processed by a computer may create a “birth certificate” or signature frequency fingerprint for a particular coke drum 5. Once a birth certificate fingerprint has been determined or established, normal operation of the decoking process may be monitored remotely.

As the “run mode” signature is received into a computer system 21 from the delayed coker operation, this run mode signature may be compared to the birth certificate signature to determine the operational mode of the delayed coker operation. In a non-limiting example, the run mode signature of a cutting tool 14 in a cutting mode would produce a run mode signature that, when compared with the birth certificate, would allow an operator at a remote location to reliably and repeatedly identify that the cutting tool 14 was in a cutting mode. Accordingly, for a given coke drum 5, the computer system 21 collects and assembles data, allowing the computer system 21 and/or operator to recognize by the data being received from one or more accelerometers 16, whether a delayed coker unit is cutting, boring and/or ramping.

In some embodiments, the accelerometer 16 receives data relating to the vibration associated with a particular cutting tool 14 which is in the cutting mode, the amplitude and frequency of the vibration is measured by the accelerometer 16 in one or more axes, and such data is transmitted through the computer system 21 to a central processing unit where the data is converted by the FFT into an FFT fingerprint that correlates with the cutting mode of a particular cutting tool 14. In other embodiments, in addition to the use of FFT, averaging and correlating fundamental signatures are also used. Accordingly, for any delayed coker unit operation, the software of the present invention will receive data from an accelerometer 16 associated with boring, cutting or ramping and will identify FFT fingerprints which correspond to the boring, cutting and/or ramping modes of a particular drill.

In some embodiments, the vibration data or the FFT fingerprint associated with boring and cutting may be translated into a simple indicator light system. For example, the system contemplates illuminating a light of a particular color (such as a green light) when the drill is in the boring mode and illuminating a different indicator light (such as a red light) when the drill is in cutting mode. This simplified indicator light system may be used to prevent user error by making it very easy for any operator to quickly assess whether the drill is in boring or cutting mode.

The present invention contemplates coupling the accelerometer 16 to at least one position into the delayed coker unit operation. The present invention contemplates coupling the accelerometer 16 by various means. In some embodiments of the present invention, the accelerometer 16 may be coupled to a portion of the delayed coker unit operation by magnetic coupling. In other embodiments, the accelerometer 16 may be bolted to the apparatus to be measured. In other embodiments, the accelerometer 16 may be placed in a “saddle” and strapped to the apparatus for which vibration is to be measured. In a non-limiting example, an accelerometer 16 may be placed in a “saddle” and strapped with stainless steel straps to the top of the drill stem 8, securing the accelerometer 16 to the drill stem 8 in a desired orientation and in a fashion that preserves the integrity of the data acquiring process by ensuring consistent positioning and contact with the drill stem 8.

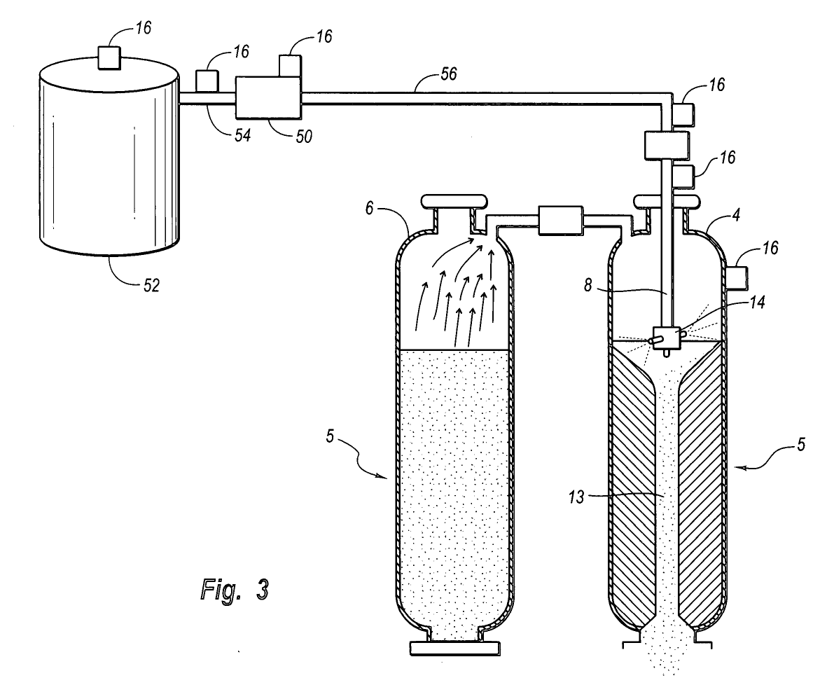

FIG. 3 illustrates an on-line coke drum 6 and an off-line coke drum 4, wherein the off-line coke drum 4 has a drill stem 8 in a partially lowered position. The cutting tool 14 of FIG. 3 is depicted as ejecting fluid in a horizontal direction from the drill head. Accordingly, the drill head depicted in FIG. 3 is in a cutting mode. FIG. 3 additionally depicts the bore hole 13 which has already been cut through the coke which allows debris to fall through to a chute below the coke drum 5. Additionally, FIG. 3 illustrates additional possible placements for accelerometers 16 in the coker unit system.

The invention contemplates attaching one or more accelerometers 16 to other positions in the delayed coker unit operation to measure the vibrational output of the cutting and boring modes of the drill. In some embodiments of the present invention, accelerometers 16 are redundantly placed and utilized in more than one position on a drill stem. Thus, in some embodiments of the invention, multiple accelerometers 16 may be attached to one drill stem to redundantly feed data to the computer operating systems 21 of the present invention for analysis.

In some embodiments, multiple accelerometers 16 may be attached to the first pipe 54—which conducts fluid from the fluid reservoir 52 to fluid pump 50—to redundantly feed data to a computer operating system 21 for analysis. In other embodiments, multiple accelerometers 16 may be attached to a second pipe 56 to redundantly feed data to computer operating system 21 for analysis. In other embodiments, multiple accelerometers 16 may be attached at any various locations in the delayed coker unit operation to feed data to a computer operating system 21.

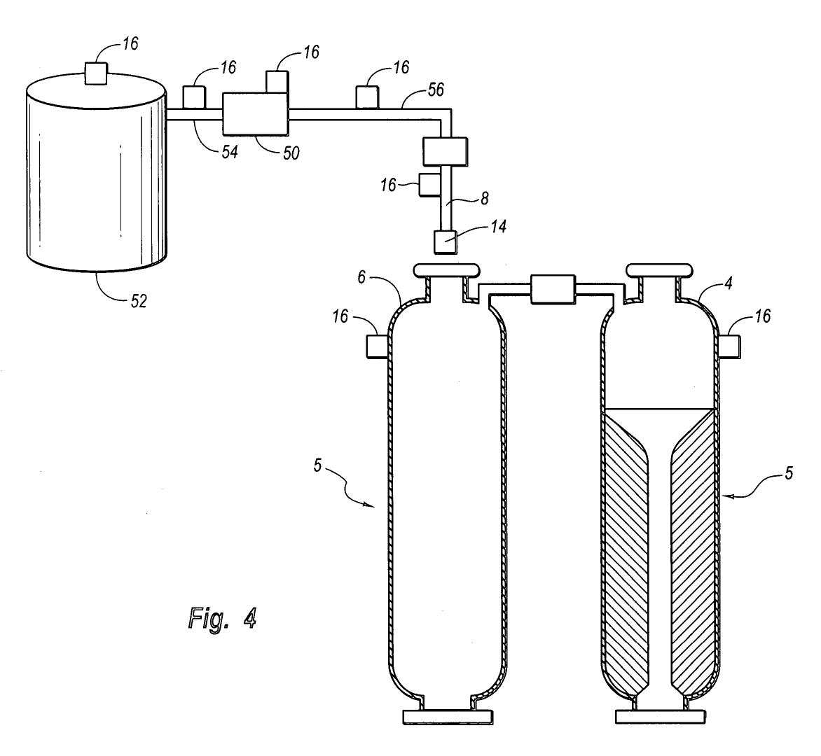

FIG. 4 illustrates a drill stem 8 in a fully raised position. In some embodiments of the present invention, the accelerometer 16 may be attached as indicated in FIG. 4 on top of the drill stem 8. Alternatively, one or more accelerometers 16 may be placed on a coke drum 5, a fluid reservoir 52, a first pipe 54, a fluid pump 50 and/or a second fluid pipe 56 to measure the vibrational status of a coke drum 5 (that is, to determine whether the drill is in cutting, boring, or ramping mode). Alternatively, one or more accelerometers 16 may be placed at more than one location throughout the delayed coker unit operation.

In some embodiments, the accelerometer 16 may further comprise an electric sensor, a temperature sensor, a digital signal processor, data memory, a wireless transceiver, internal battery, and/or an internal antenna. In some embodiments, the accelerometer 16 may be preferably powered with an internal lithium battery wherein the solid state accelerometer 16 collects and transmits vibration data securely by a wireless link. The data collection parameters may be configured from a network Windows® computer. In some embodiments of the invention, the accelerometer 16 is completely wireless. In other embodiments, the accelerometer 16 is wired to a computer system 21.

In some embodiments of the present invention, the accelerometer 16 is vibration and/or temperature sensing. In some embodiments of the invention, the accelerometer 16 measures or has a 0.5 Hz to 10 kHz frequency response with 1 Hz to 40 kHz sampling speed. In other embodiments of the invention, the accelerometer 16 measures or has a frequency response below 0.5 Hz 1. In other embodiments, the accelerometer 16 measures or has a frequency response above 10 kHz. In a non-limiting example, the accelerometer 16 has a frequency response at 0.01, 0.1, 0.2, 0.3, 0.4, 0.5, 1, 2, 3, 4, 5, 6, 7, 8, 9, 10, 11, 12, 13, 14, 15, 20, 30, 50, 60, 70, 80, 90 and/or 100 kHz. In other embodiments, the accelerometer has a sampling speed of less than 1 Hz. In other embodiments, the accelerometer has a sampling speed of more than 40 kHz. Accordingly, in a non-limiting example, the accelerometer has a sampling speed of 0.5 Hz, 1 Hz, 10 Hz, 20 Hz, 30 Hz, 40 Hz, 50 Hz, 60 Hz, 70 Hz, 80 Hz, 90 Hz, 1 kHz, 10 kHz, 20 kHz, 30 kHz, 40 kHz, 60 kHz, 80 kHz, 100 kHz, and/or more than 100 kHz.

In some embodiments, the accelerometer 16 is software selectable between the 5 g and 50 g range. In some embodiments, the accelerometer 16 is software selectable to less than 5 g and/or more than 50 g. Accordingly, in a non-limiting example, the accelerometer software is selectable to 1 g, 10 g, 20 g, 30 g, 40 g, 50 g, 60 g, 70 g, 80 g, 90 g, 100, and/or more than 100 g. In some embodiments, the accelerometer 16 produces time trace, FFT and overall data formats and may transmit data up to 250 feet. In some embodiments, the accelerometer 16 produces time trace, FFT and overall data formats and may transmit data more than 250 feet. Accordingly, in some embodiments, the accelerometer may transmit data to 300 ft, 400 ft, 500 ft, 600 ft, 700 ft, 800 ft, 900 ft, 1000 ft, 2000 ft, 3000 ft, 4000 ft, 5000 ft, 10000 ft and/or more than 10000 ft. In some embodiments, the accelerometer 16 has an easily replaceable battery with a life span that lasts for more than two (2) years.

In some embodiments, the active repeater 18 of the invention may operate when sensors 16 are out of range of the network access points 20. This can occur if a sensor or accelerometer 16 is greater than 250 feet from the network access point 20 or if an object is shielding the signal emitted from the accelerometer 16. The active repeaters 18 used in some embodiments may have the benefit of being completely wireless, easy to install, have a range of up to 250 feet, have easily replaceable batteries, and transmit encrypted air corrected wireless data utilizing solid state (that is, no moving parts).

In some embodiments of the invention, the network access point 20 of the present invention bridges the gap between the wireless sensor network and the computer devices 22, 24, of the present invention. Thousands of accelerometers 16 may share the same wireless network hosted by one or more network access points 20. The existence of network access points 20 allows multiple accelerometers to send data to computer devices 22, 24 in the computer system 21. In some embodiments, the network accessing point 20 stores data records in an off-line mode and encrypts error corrected wireless transmissions or utilizes error corrected wirelessly transmitted data from the data collectors, namely the accelerometers 16, of the present invention. The network access point 20, in some embodiments, communicates with the central processing units of the computer devices of the present invention utilizing either wireless connections or Internet connections.

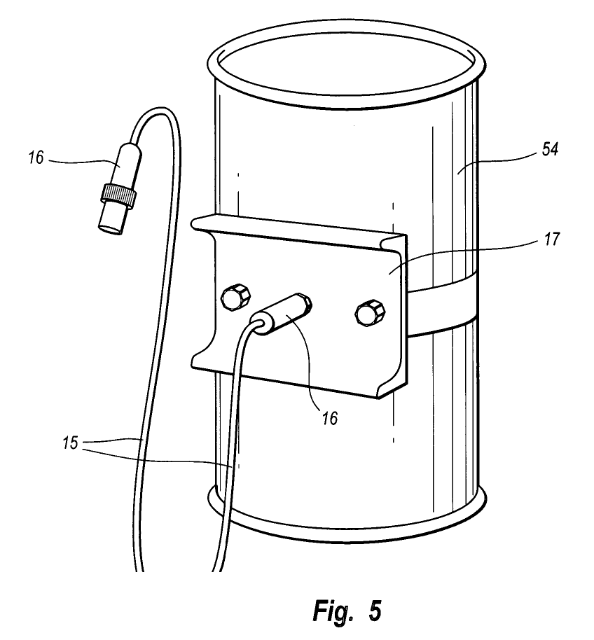

FIG. 5 depicts two accelerometers 16 positioned on a water or fluid pipe 54 that may represent either pipe 54 or pipe 56 shown in the previous Figures. As depicted in FIG. 5, more than one accelerometer 16 may be utilized to measure vibrational data at any given point in the operation. As depicted in FIG. 5, the accelerometers 16 are coupled to a mount 17 and connected to wires 15 that connect them to a computer operating system 21 so that the accelerometers 16 can transmit data to a computer for analysis. As depicted in FIG. 5, various accelerometers 16 may be oriented in different axes to acquire multiple data sets in order to confirm the operational status of a cutting tool 14 in a delayed coker operation. In a non-limiting example, and as depicted in FIG. 5, one accelerometer 16 may be placed to measure vibration in a horizontal axis while another accelerometer 16 may be placed to measure vibration in a vertical axis. Accelerometers 16 as depicted in FIG. 5 may be positioned likewise throughout the delayed coker unit operation.

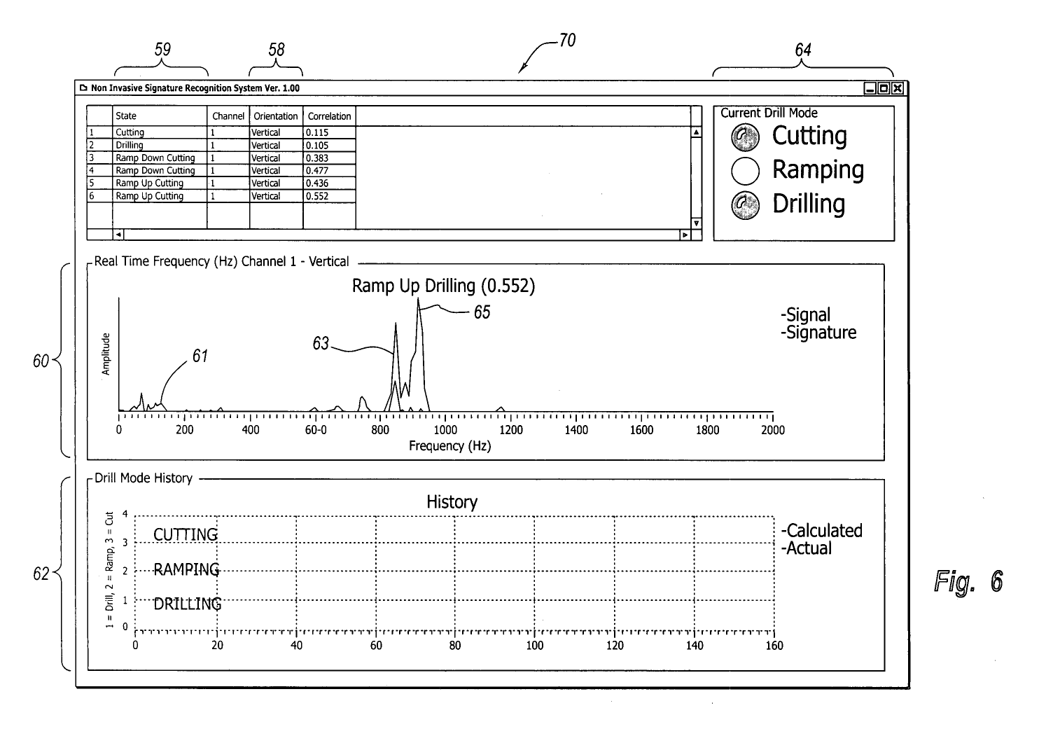

FIG. 6 depicts a display screen 70 that may be displayed on a computer monitor and utilized by an operator, technician or engineer to monitor and/or analyze whether a cutting tool 14 is cutting, drilling, or ramping during delayed coker unit operation. As depicted, the display 70 may indicate what mode—ramping, cutting, or drilling—the drill is in at a current time and may indicate the orientation axes from which the data is being received. As depicted in FIG. 6, the orientation axes here being measured is vertical 58.

Additionally, data related to the real time frequency in Hertz for a particular accelerometer 16 may be displayed 60. The real time frequency may be utilized to analyze the frequency associated with drilling, cutting, ramping, or other processes in delayed coker unit operations, including the vibration associated with the water pump 50.

Additionally, as depicted in FIG. 6, the drill mode history 62 may be displayed allowing an operator or other person to analyze the history of drilling, ramping, or cutting that has occurred over a period or minutes, hours, days, weeks, years or longer.

In addition to the data illustrated by FIG. 6, the present invention contemplates allowing users to access and productively use and modify other data sets. As depicted in FIG. 6, a display 70 may also contain a simple indicator light 64 which would allow an operator to determine a current drill mode, including whether the drill is cutting, ramping, or drilling.

Shown also in FIG. 6 are examples of some features that may be part of the display 70: computed correlations 59, a signal 63, a pump signature 61, and a birth certificate 65 comprising, for example, drilling and cutting signatures.

As mentioned, a vibration monitoring system is provided for monitoring the vibration at any point in the delayed coker unit operation. In a non-limiting example, some embodiments relate to continuous monitoring and detection of reduced material thickness in elbows and pipes that are carrying high temperature and/or high pressure fluids or gases.

In some embodiments, the monitoring system may be utilized to measure bearing wear. In a preferred embodiment, bearing deterioration can be detected before failure of critical rotating machinery that is either not being monitored or is only being periodically monitored.

In some embodiments, the monitoring system may be used for detecting coke clogging the furnace pipes that are heating the petroleum before going into the coke drum.

In some embodiments, the monitoring system may be used to monitor/detect the movement of fluids and/or gas in pipes.

In some embodiments, other characteristics such as heat, pressure, sound, and/or some other quantifiable characteristic may be monitored instead of or as well as vibration characteristics.

Heretofore, the embodiments have been discussed in terms of using sensors or accelerometers 16 to determine the mode of the cutting tool 14. Some embodiments of the present invention also contemplate similarly using sensors or accelerometers 16 to detect vibrations in the coker unit system during the coking process so as to determine coke and foam levels inside the drum 5 so as to prevent undesirable drum outage and promote more efficient operation of the coking unit.

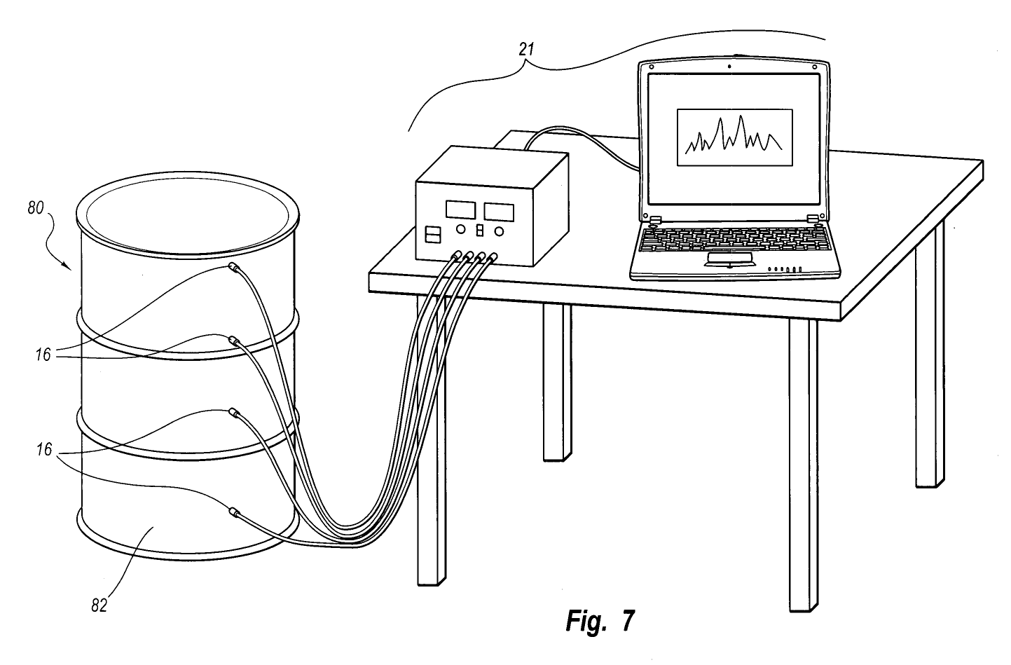

FIG. 7 illustrates a simulation wherein a 26″ high, 20″ wide drum 80 was filled with different fill levels of material having approximately the same density as coke. An input force or impulse was applied at a point 82 on the drum 80 to simulate the natural movement of a coke drum 5 being filled. Four accelerometers 16 were positioned vertically on the drum and connected to a computer system 21. Software in the computer system 21 was used to obtain signatures at different material levels.

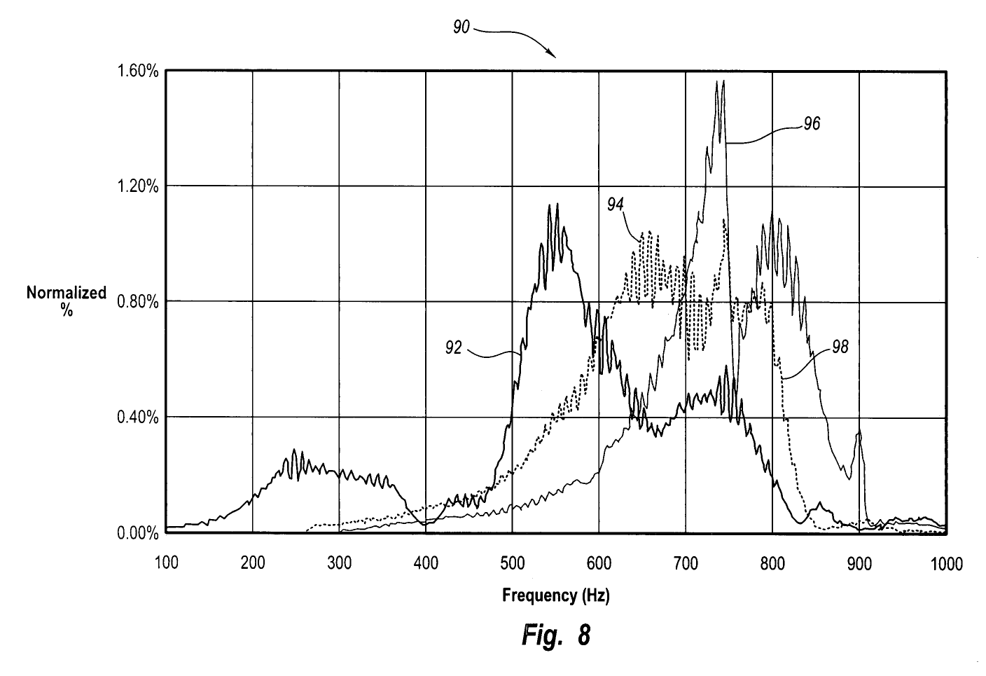

FIG. 8 shows a display 90 of four different signatures, 92, 94, 96, and 98 corresponding, respectively, to 12″ fill, 18″ fill, 24″ fill, and 26″ fill (top). Thus, in this simulation, it was shown that embodiments of the present invention were successfully able to obtain useful fill information.

Embodiments of the present invention that involve the use of sensors or accelerometers 16 to determine the coke level in the drum 5 are implemented similarly to the embodiments of the present invention utilized to determine cutting tool 14 status, and the previous discussion of the various embodiments may be applied to embodiments used for coke or foam level measurement. Vibration monitoring systems for monitoring coke or foam levels preferably measure the levels with respect to the top of the drum 5 and include one or more sensors or accelerometers 16 coupled to a coking system and a computer system 21. As with the sensors 16 used for determining cutting tool 14 status, the sensors 16 used to determine coke or foam level status may be placed in any position or location in the coking system, in any orientation, and corresponding to various axes. Preferably, the sensors 16 in the coke or foam level measuring system are coupled to the outside of the drum 5. In some embodiments, the sensors or accelerometers 16 are placed vertically on a drum 5. More particularly, some embodiments contemplate four accelerators 16 placed vertically in a line on a drum 5 in a manner similar to that shown in the simulation of FIG. 7.

We claim:

1. A vibration monitoring device comprising:
at least one transducer coupled to a component in a delayed coker unit system, the transducer providing an output signal representative of a physical characteristic at said component;
a computer-readable medium, operatively connected to said transducer, that provides computer-executable instructions for modifying the output signal; and
a display, operatively connected to said computer-readable medium, that indicates an operational status of said delayed coker unit system.

2. The device of claim 1 wherein said transducer comprises an accelerometer.

3. The device of claim 2 wherein said at least one transducer comprises a plurality of accelerometers placed vertically along a coke drum.

4. The device of claim 3 wherein said plurality of accelerometers comprise four accelerometers.

5. The device of claim 1 wherein said component comprises a cutting tool.

6. The device of claim 1 wherein said component comprises a drill stem of a cutting tool.

7. The device of claim 1 wherein the transducer is coupled to said component via a mounting device.

8. The device of claim 1 wherein said component comprises a coke drum.

9. The device of claim 1 wherein said component comprises a fluid line.

10. The device of claim 1 wherein said component comprises a fluid pump.

11. The device of claim 1 wherein said component comprises a fluid reservoir.

12. The device of claim 1 wherein said physical characteristic is selected from the group consisting of vibration, temperature, pressure, and acoustics.

13. The device of claim 1 wherein said instructions for modifying the output signal comprises instructions for performing a Fast Fourier Transform.

14. The device of claim 1 wherein said operational status comprises the status of the cutting tool inside a coke drum that is being decoked.

15. The device of claim 1 wherein said operational status comprises the status of a cutting tool, said status being selected from the group consisting of cutting, boring, and ramping.

16. The device of claim 1 wherein said operational status comprises the level of coke inside a coke drum being filled during a coking operation.

17. The device of claim 1 wherein said operational status comprises the level of foam inside a coke drum being filled during a coking operation.

18. The device of claim 1 wherein the instructions for modifying the output signal comprise running the output signal through a Fast Fourier Transform to create a Fast Fourier Transform fingerprint.

19. The device of claim 1 wherein the display further outputs an operational history.

20. A device for monitoring the cutting tool in a delayed coker unit operation comprising:
at least one vibration sensor connected to a delayed coker unit; and
a computer system connected to said sensor, said computer system comprising a component that can translate a signal transmitted from said sensor.

21. The device of claim 20 wherein said at least one vibration sensor comprises a plurality of accelerometers.

22. The device of claim 20 wherein said computer system transforms said signal into a signature frequency fingerprint.

23. The device of claim 20 wherein said signal is transmitted to an active repeater that, in turn, sends the signal to a network connection that is part of said computer system.

24. The device of claim 20 wherein said computer system further comprises software that translates said signal into a birth certificate via a Fast Fourier Transform.

25. A device for monitoring levels of material produced inside a coke drum during coke production, said device comprising:
at least one vibration sensor connected to a delayed coker unit; and
a computer system connected to said sensor, said computer system comprising a component that can translate a signal transmitted from said sensor.

26. The device of claim 25 wherein said at least one vibration sensor comprises a plurality of accelerometers.

27. The device of claim 25 wherein said computer system transforms said signal into a signature frequency fingerprint.

28. The device of claim 25 wherein said signal is transmitted to an active repeater that, in turn, sends the signal to a network connection that is part of said computer system.

29. The device of claim 25 wherein said computer system further comprises software that translates said signal into a signature frequency fingerprint via a Fast Fourier Transform and thereby allows a user to recognize when.

30. The device of claim 25 wherein said material comprises coke.

31. The device of claim 25 wherein said material comprises foam produced during the production of coke.

32. The device of claim 25 wherein said vibration sensor comprises four vibration sensors coupled vertically to said drum.

33. A system for determining a Fast Fourier Transform wave pattern associated with an operational status of a delayed coker drum operation, said system comprising:
a sensor, coupled to a component in a delayed coker drum system, that generates data representing real-time physical characteristics of said component;
a signal generator that transmits the data;
a signal receiver that receives the data;
software for running a Fast Fourier Transform that converts the data into a useable waveform;
a central processing unit that identifies said operational status by evaluating the waveform; and
a display operatively connected to said software.

34. The system of claim 33 wherein said operational status comprises boring and cutting.

35. The system of claim 33 wherein said operational status comprises the fill level of coke inside of a coke drum.

36. The system of claim 33 wherein said operational status comprises the fill level of foam located on top of coke inside of a coke drum.

37. A system for determining a Fast Fourier Transform wave pattern associated with the cutting, boring, and ramping modes of a cutting tool inside a coke drum comprising:
a vibration sensor, coupled to a portion of a decoking system, the vibration sensor generating data during decoking;
a central processing unit that converts the data to a useable waveform;
a central processing unit that identifies, via said waveform, the mode of the cutting tool; and
a display operatively connected to said central processing unit for indicating the mode of the cutting tool.

38. A system for determining a Fast Fourier Transform wave pattern associated with the level of material produced inside a coke drum during coke production, said system comprising:
a vibration sensor, coupled to a portion of a decoking system, the vibration sensor generating data during coking;
a central processing unit that converts the data to a useable waveform;
a central processing unit that measures, via said waveform, the level of fill of said material within said drum; and
a display operatively connected to said central processing unit for indicating said level of fill.

39. A method of determining the operational status of a delayed coker drum operation, said method comprising:
mounting a transducer at a position in a delayed coker unit operation to provide an output signal related to movement at said position;
processing the output signal; and
determining the operational status via the processed output signal.

40. The method of claim 39 wherein said determining comprises determining whether a cutting tool is boring, cutting, or ramping.

41. The method of claim 39 wherein said determining comprises determining various fill levels of material inside a coke drum.

42. The method of claim 39 wherein said processing comprises running the output signal through a Fast Fourier Transform.
